(19) United States
(12) Patent Application Publication
(10) Pub. No.: US 2003/0065728 A1
(43) Pub. Date: Apr. 3, 2003

(54) Filing and retrieval of e-mail into person associated folders

(76) Inventor: Rajko Milovanovic, Plano, TX (US)

Correspondence Address: TEXAS INSTRUMENTS INCORPORATED, P O BOX 655474, M/S 3999, DALLAS, TX, 75265

(21) Appl. No.: 10/215,522

(22) Filed: Aug. 9, 2002

Related U.S. Application Data
(60) Provisional application No. 60/325,408, filed on Sep. 28, 2001.

(51) Int. Cl. G06F 15/16

(52) U.S. Cl. 709/206; 707/7

(57) ABSTRACT

A method of filing e-mail messages is provided wherein when setting up each e-mail folder or at any point in time later on the e-mail user can assign or remove one or more person's name (senders or recipients of user's e-mail) the folder. When sending or receiving an e-mail message the e-mail user uses the address information such as at TO, FROM or CC to file the e-mail message or pointer to the e-mail message in the folder or folders with the assigned peoples people names. Similarly a keyword may be assigned to a folder and the keyword in a title of the message using for filing in the folder. The method may be automatically filed or semi-automatic filed by the system highlighting the person or keyword for which the e-mail is to be filed to and selecting or overriding. The messages are retrieved from all of the folders using the person's name or keyword.

### FIELD OF INVENTION

This invention relates to electronic mail or e-mail and more particularly to filing and retrieval of e-mail.

### BACKGROUND OF INVENTION

The use of electronic mail or e-mail has expanded rapidly over the last few years due to the use of the Internet and application programs such as Microsoft Overlook. The use of e-mail is continuing to expand due to the use of the wireless devices such as Blackberry and Palm Pilot. Further expansion is seen for e-mail being used to transmit audio, voice and video. These uses include the sending of music via the Internet, digital photographs from digital cameras, and video from TV Set Top Boxes.

The problem is that many e-mail users already receive a great many e-mail messages per day and the users spend a great deal of time processing e-mail messages. Most messages can be simply deleted because they have no lasting value. Some, however, need to be saved. Also many messages are sent and many of these messages also need to be saved. The problem with the standard process of keeping all messages that are not deleted in one large archive is how to find them. One method of finding them is to search the archive using a keyword or name in the sum of the entire body or bodies of all archived e-mail messages. This is not a practical solution for e-mail users who have a lot of e-mail messages a day; e-mail users whose e-mail needs to be perused by others such as administrators and collaborators, or other members of a firm; or e-mail users who need to access an e-mail item with more substantial information such as when the user receives the e-mail from a low bit per second link such as Blackberry when traveling.

As opposed to one huge shoebox for receiving everything, many users have some sort of directory structure for their e-mail (archive or other) and/or computer system. Examples include, but are not limited to, folders for accounts or customers or suppliers or partners or other stakeholder firms, or even their organization parts of a manager's own firm, or manager's area of responsibility, or some mix of these.

It would be best for e-mail users if each not deleted e-mail message (or pointer to it ) could be filed into each (not necessarily only one per e-mail message) pertinent folder. The time and effort of finding the correct folder(s) for each “not delete” message and then dragging the e-mail message into each pertinent folder (including user-producing multiple copies or pointers) into all pertinent folders today deters most e-mail users from doing so. The time and trouble doing this often exceeds the benefit.

It is therefore highly desirable that an improved method and system is provided for enabling this filing of each sent or received e-mail message into all pertinent folders to happen as automated as possible.

### SUMMARY OF INVENTION

In accordance with one embodiment of the present invention an improved filing system comprises setting up e-mail folders by assigning person's names to the folders and sending e-mail messages to be filed to the folder(s) containing the person's name.

### DESCRIPTION OF DRAWING

FIG. 1 illustrates an e-mail system according to one embodiment of the present invention.

FIG. 2 is a flow chart of the system of FIG. 1 according to one embodiment of the present invention.

FIG. 3 illustrates a highlighted folder.

FIG. 4 illustrates the display of selecting a folder for e-mail.

FIG. 5 illustrates an address book.

### DESCRIPTION OF PREFERRED EMBODIMENTS

FIG. 1 illustrates an e-mail system using a personal computer according to one embodiment of the present invention. The system 10 includes a processor 11, a keyboard and/or mouse 13, a display 15 and a modem 17 coupled to the Internet 19. The system 10 includes the memory 21 with folders. The system 10 could be also be a wireless system or small bit per second device such as a Palm Pilot or Blackberry. The processor 11 may include software application such as Microsoft Window and Outlook with a file manager. The file manager 11a in the processor 11 processes the messages in and out of the folders in the memory 21. The processor II generates the displays and processes the instructions from the keyboard/or mouse 13 or similar input/output control device.

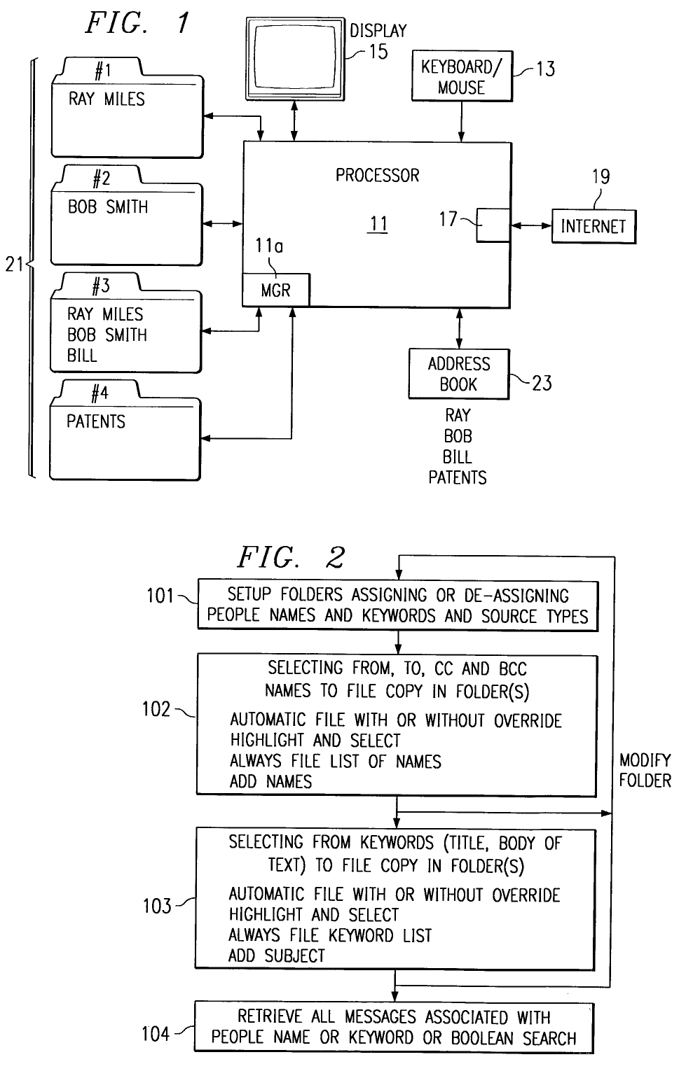

In accordance with an embodiment of the present invention of FIG. 2 the processor 11 is programmed to follow the flow chart of FIG. 2. The first step 101 is to set up file folders such as folders #1-#4 in memory 21 by assigning people names, such as “Bob Smith” to folders #2 and #3 and/or “Ray Miles” to folders #1 and #3 where folder #1 may be labeled, for example, for inventors and folder #3 may be labeled for agreements and folder #2 may be labeled for Bob Smith's invoices. The step 101 is also for assigning keywords to a folder such as “Patents” to folder #4 which may be labeled for patents or “Patents” may be a keyword for a folder for activities. Folder #4 may also contain names such as inventors. When setting up the e-mail and/or file system folder, or at any time later on, the e-mail user assigns one or more person's names (sender or recipient of user's e-mail messages) to a folder. This assignment records a pointer to that folder memory address for incoming or outgoing email addresses. A given person's name can also be assigned to multiple folders as indicated by folder #3. Similarly, the user can de-assign one or more person's names (sender or recipient) from one or multiple folders. This assignment or de-assignment happens much less frequently than sending or receiving individual e-mail messages. The folders with assigned people's names are visually differentiated from those folders without people's names.

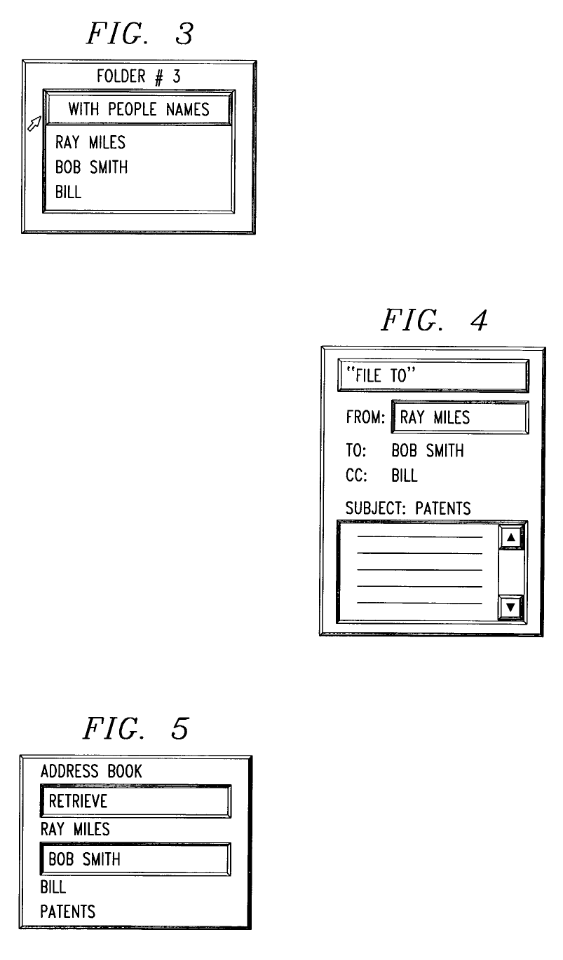

In accordance with one embodiment of the present invention, the folder may always display the assigned names such as Bob Smith and Ray Miles to the folder. In accordance with another embodiment, the display 15 may present the title “with people names” and the user may place a cursor over the title by mouse or keyboard and the system generates and displays the list of person's names such as Bob Smith, Ray Miles and Bill that are assigned to the folder #3. This is illustrated by FIG. 3.

When sending or receiving e-mail messages, the e-mail user selects names of each FROM, TO, CC, BCC person to whose associated folder(s) user wants to file under and in this manner effects a copy of the e-mail message (or pointer to it is saved). Whenever the user has an exchange such as send, receives e-mail, etc. with Ray Miles a copy of that message is automatically placed in all folders which have Ray Miles' name assigned to the folder. This is indicated by step 102 in FIG. 2. The selection may be by use of a double click of a mouse or other selection device. The system may highlight the clicked name to indicate “file to” status and need to be unclicked to change the “file to” status to not file in the folder(s). FIG. 4 illustrates Bob Smith's received message from Ray Miles (FROM) is highlighted to store under Ray Miles. Similarly, if Bob Smith sent a message to Ray Miles the sent message could be highlighted at “TO” to store under Ray Miles and if highlighted at “FROM” stored under Bob Smith. If “Bill” “CC” is highlighted it is stored under Bill.

In accordance with another embodiment, the system can offer the option of default names for filing such “FROM” person for e-mail received and “TO” person for messages sent. The default names may be highlighted as “ones for filing”, such as “Ray Miles” highlighted in FIG. 4 or “Bob Smith” highlighted when sent from Bob Smith or “Bill” highlighted when copied. The user can stop the default filing for e-mail messages, or override it selectively for individual messages by, for example, using the name or the selector to “unclick” the “file to” status.

The user can designate some (or all) words in the name of any folder to be “file to” keywords in step 103. In this case the system files by default similar to person names to all keywords matching keywords from the subject line of the message. The saving in the folder with the associated keyword may involve any of the operations such as highlighting and clicking on the keyword to indicate “file to” or unclicking for default, etc. For example, the subject of the e-mail “Patents” in FIG. 4 may be highlighted and filed to folder #4 with the assigned keyword “Patents.”

If “file to” highlights exist, users “Send” (Outgoing) or Read (open a received e-mail message ) action for e-mail message automatically cause the system to carry out filing as highlighted. If no highlights, there is no filing.

To retrieve all messages with a given person's name the user selects the person's name in one or more address books in a similar manner to highlighting on the name in the address book 23 and then clicking on that with a mouse left click for example as indicated in Step 104 of FIG. 2. To retrieve all from “Bob Smith” for example, the user goes to the address book and selects by highlighting “Bob Smith” from and right clicking on the mouse switch for example and the system lists all e-mail messages (from folders #2 and #3 for example) for “Bob Smith.” The same is done for any person or persons selected from the address book. The system may list all e-mail messages in a folder on a folder by folder ordering and chronological basis within each folder or the other way around. When the file is set up and the “file to” is done the address book is provided with a pointer to the file location to address the file when retrieved.

Likewise the user may use the address file to retrieve all messages associated with given keywords such as “Patent” in the title or subject for example. The messages are selected from the folders by selecting from the folders with keywords. The messages are provided on a folder-by-folder basis and chronologically in each folder of the other way around.

The system in Step 104 may likewise use a Boolean type search by selecting those with a selected person's name and keyword.

In addition the folders in Step 101 can be named for the e-mail source types such as text, prerecorded audio music, pictures such as from a digital camera or scanner or video for video from a Television Set Top Box and the assigned names identify the associated people or keywords. These can all be used to select “music from Bob” for example.

The e-mail user can a priori designate people from the user's e-mail (or other) address book to be automatically “file to” whenever their names appear in “FROM”, “TO”, “CC”, and “BCC” lines of sent or received mail. One's boss, or key customer, or key supplier are good candidates for this. For example, a message to from Ray Miles to Bob Smith may also go to Bill in folder #3 if Bill reviews Bob's invention agreements.

The user can also predefine a list of keywords to be “filed to” keywords in folder names and these can be found in the message body or title as discussed previously.

The system can offer the e-mail a chance (window for example) to type in a people's names and/or subject line or message body to be “filed to.” When adding or removing a person's name or keyword or source the folders are automatically modified as indicated by the return back to Step 101 in FIG. 2.

When the e-mail user moves or copies or renames a folder, the file manager in the processor system automatically prompts for user's confirmation of “file to” associations such as names and keywords for the moved or copied or renamed folder. The system displays the files in the folder such as for folder #3 the filed messages of Ray, Bob and Bill and these files are prompted on the display and selectively moved or copied to a new file or placed in a renamed file.

While the invention is described in the context of preferred embodiments, it will be apparent to those of ordinary skill in the art that the present invention may be modified in numerous ways and may assume many embodiments other than that specifically set out and described above. Accordingly, it is intended by the appended claims to cover all modifications of the inventions which fall within the spirit and scope of the invention.

In the claims:

1. A method of filing e-mail messages comprising the steps of: setting up folders with assigned people names and filing e-mail messages in folders with assigned people names using address information on the messages.

2. The method of claim 1 wherein said filing of e-mail messages is automatic using address information.

3. The method of claim 2 including providing means for overriding automatic filing to the address information.

4. The method of claim 1 wherein said filing includes highlighting the people names and selecting.

5. The method of claim 1 including the step of retrieving messages from one or more folders using people names.

6. The method of claim 1 including setting up folder(s) with keywords and filing e-mail messages in folders using keyword information.

7. The method of claim 6 wherein said keyword is in the subject or title of the message.

8. The method of claim 6 wherein said keyword is in the message body.

9. The method of claim 6 wherein filing of keywords is automatic.

10. The method of claim 6 including selectively overriding automatic filing of keywords.

11. The method of claim 6 including retrieving messages from folder or folders using people names and keywords.

12. The method of claim 9 wherein said method includes retrieving messages using Boolean search criteria.

13. The method of claim 6 wherein said filing of keywords includes highlighting.

14. The method of claim 6 wherein said filing includes providing a list of always file people names and/or keywords and whenever the person or keyword appears in the e-mail message filing the e-mail messages to those folders with the assigned people names and/or keywords.

15. The method of claim 1 wherein said folders are assigned source types of e-mail messages including text and audio, digital pictures, and/or video.
